(19) United States
(12) Patent Application Publication
(10) Pub. No.: US 2015/0350917 A1
(43) Pub. Date: Dec. 3, 2015

(54) OPPORTUNISTIC CHANNEL REUSE IN A SHARED COMMUNICATION MEDIUM

(71) Applicant: QUALCOMM Incorporated, San Diego, CA (US)

(72) Inventors: Srinivas Katar, Gainesville, FL (US); Hao Zhu, Ocala, FL (US); Lawrence Winston Yonge, III, Summerfield, FL (US)

(73) Assignee: QUALCOMM Incorporated, San Diego, CA (US)

(21) Appl. No.: 14/287,310

(22) Filed: May 27, 2014

(51) Int. Cl. H04W 16/14; H04W 72/10; H04W 72/04

(52) U.S. Cl. CPC H04W 16/14; H04W 72/044; H04W 72/10

(57) ABSTRACT

Channel reuse permits more than one station to communicate concurrently via a communication medium. A first station may transmit a first transmission to a second station. A third station may detect the first transmission and determine a channel a channel reuse time period for a second transmission transmitted from the third station to a fourth station via the communication medium at least partially concurrently with the first transmission. The channel reuse time period may be based at least in part on estimated time to a next priority resolution slot (PRS) of the communication medium as determined from information in a start of frame (SOF) delimiter of the first transmission. The channel reuse time period may take into account a media access control (MAC) protocol data unit (MPDU) burst, and/or time periods associated with acknowledgement messages.

### BACKGROUND

Embodiments of the present disclosure generally relate to the field of communication networks, and, more particularly, to channel reuse in a communication network.

In many communication systems (e.g., satellite communication systems, wireless communication systems, powerline communication (PLC) systems, coaxial cable communication systems, telephone line systems, etc.), the communication medium can be shared among multiple communication stations. In a shared communication medium, carrier sense multiple access (CSMA) protocols can be employed to minimize interference between communication stations in the shared communication medium. In accordance with the CSMA protocols, a transmitting communication station can “sense” the communication medium and transmit on the communication medium after verifying the absence of other traffic on the shared communication medium. If the channel is currently occupied, the transmitting communication station can defer its transmission until the channel becomes available.

In a shared communication medium, two or more stations may be able to transmit concurrently via the same communication channel, thus “reusing” the communication channel. Traditional channel reuse techniques may specify predetermined channel reuse patterns. For example, in accordance with the traditional channel reuse techniques, a channel allocation mechanism can be used to allow spatially separate stations use the same channel at designated time periods. However, greater throughput associated with channel reuse may be achieved using flexible channel reuse time periods.

### SUMMARY

Various embodiments are described to facilitate channel reuse. Channel reuse refers to the concurrent use of a same communication medium by more than one station. During channel reuse a station may transmit at least partially concurrently via the communication medium as another station.

In one embodiment, a first transmission, via a communication medium, from a first station to a second station is detected by a third station coupled to the communication medium. The third station may determine a channel reuse time period based at least in part on estimated time to a next priority resolution slot (PRS) of the communication medium. The estimated time to the next PRS may be based at least in part on information in a start of frame (SOF) delimiter of the first transmission. The third station may transmit, via the communication medium, a second transmission from the third station to a fourth station during the channel reuse time period. The second transmission may occur at least partially concurrently with the first transmission and may end before the next PRS of the communication medium.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example system to introduce concepts of this disclosure.

FIG. 2 illustrates behavior of stations in a typical CSMA network.

FIG. 3 illustrates an example media access control (MAC) protocol data unit (MPDU) format.

FIG. 4 illustrates an example carrier sense range and an example transmission range in accordance with an embodiment of this disclosure.

FIG. 5 depicts a flow diagram with example operations for communicating in a powerline communication (PLC) network in accordance with an embodiment of this disclosure.

FIG. 6 is an example timing diagram illustrating channel reuse with aligned acknowledgement messages in accordance with an embodiment of this disclosure.

FIG. 7 is another example timing diagram illustrating channel reuse without aligned acknowledgement messages in accordance with an embodiment of this disclosure.

FIG. 8 is another example timing diagram illustrating channel reuse in which a delayed acknowledgement message is used in accordance with an embodiment of this disclosure.

FIGS. 9A-9D are example timing diagrams illustrating channel reuse with a packet burst in accordance embodiments of this disclosure.

FIG. 10 depicts a flow diagram with example operations for channel reuse with a packet burst in accordance with an embodiment of this disclosure.

FIG. 11 is a conceptual diagram to illustrate determination of opportunistic channel reuse in accordance with an embodiment of this disclosure.

FIG. 12 depicts an electronic device capable of implementing various embodiments of this disclosure.

### DESCRIPTION OF EMBODIMENT(S)

The description that follows includes exemplary systems, methods, techniques, instruction sequences and computer program products that embody techniques of the present disclosure. However, the described embodiments may be practiced without these specific details. For instance, although examples refer to channel reuse operations in a powerline communication (PLC) network, embodiments are not so limited. In other embodiments, the channel reuse operations can be implemented by network devices in other suitable shared-medium communication networks, such as wireless local area networks (WLAN), coax networks, phone line local area networks, etc. In some instances, well-known instruction instances, protocols, structures and techniques have not been shown in detail in order not to obfuscate the description.

In many widely used communication media, such as satellite systems, wireless systems, powerline, coaxial cable, and telephone line, a signal received by a station might be the sum of attenuated transmitted signals from a set of other stations, corrupted by distortion, delay, and noise. Such media, called multi-access media, are the basis for local area networks (LANs), metropolitan area networks (MANs), satellite networks, and cellular networks. In such communication systems, signals from stations other than the desired transmitter station are considered as interference at the receiver station. According to modern communication theory, a signal can be successfully received if the signal-to-interference-plus-noise ratio (SINR) at the receiver station is greater than a threshold. This gives the opportunity to improve the capacity of multi-access communication systems by allowing a set of stations that do not cause strong interference to each other, to reuse the same communication medium concurrently. The approach is called channel reuse.

In accordance with this disclosure, channel reuse may be improved by dynamically determining whether to perform channel reuse, and a channel reuse time period, on a per transmission basis. A channel reuse time period may be determined for a transmitting station to utilize the communication medium concurrently with one or more transmissions from another transmitting station. A station may observe a SOF delimiter of a received first transmission. Based on information in the SOF delimiter, the station may determine that it can concurrently transmit to another station. The channel reuse time period may also be determined based at least in part on the SOF delimiter of the received first transmission. For example, the channel reuse time period may be based on a duration of the first transmission as specified in the SOF delimiter of the first transmission. The channel reuse time period may be limited so that the second transmission occurs at least partially concurrently with the first transmission and so that the second transmission concludes prior to a later transmission (such as a subsequent transmission or acknowledgement). Determinations regarding duration may be made on a per-transmission basis (based on a single transmission frame or a burst of transmission frames).

In accordance with this disclosure, the channel reuse time period may be based at least in part on a time period for an acknowledgement message associated with the first transmission. For example, selective acknowledgement (SACK) transmissions associated with each of the first transmission and second transmission may be aligned based on the channel reuse time period. Alternatively, the channel reuse time period may be determined so that a SACK message occurs during the first transmission. In another alternative, the SACK message may be delayed until a later transmission opportunity, and transmitted as a delayed acknowledgement.

In accordance with this disclosure, channel reuse may also be used to take advantage of simultaneous transmissions during a burst of MPDUs (referred to as an MPDU burst). During the MPDU burst from a first station to a second station, a third station may align one or more transmissions from the third station to a fourth station to occur in relation to the MPDU burst frames. Described are several ways to align the transmissions in relation to the MPDU burst frames.

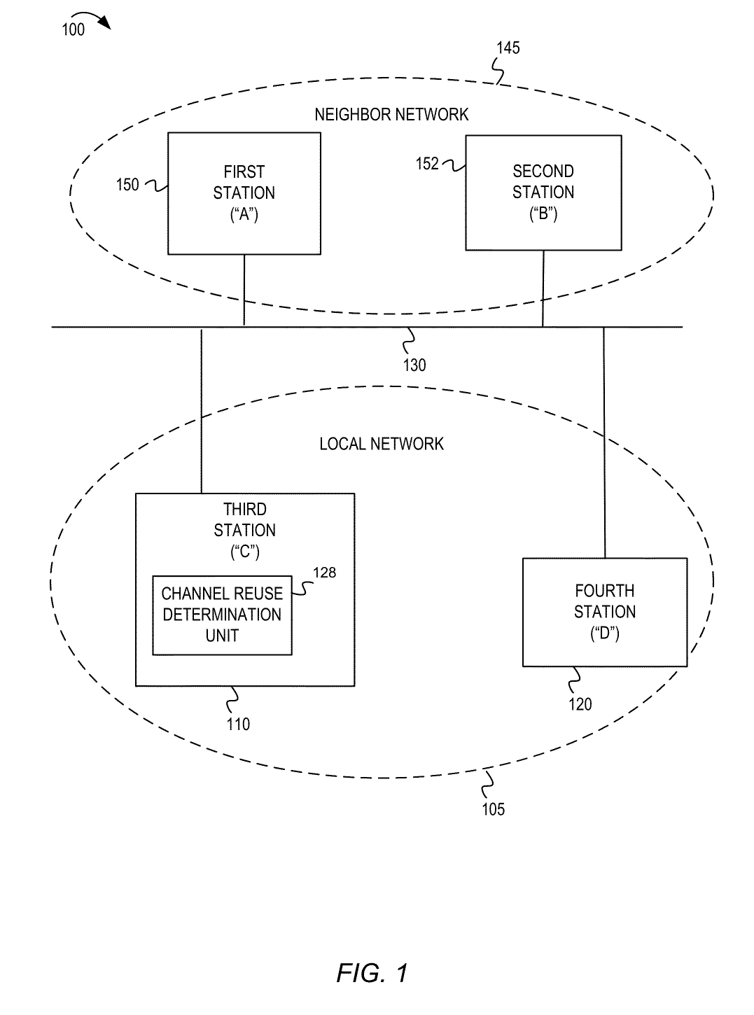

FIG. 1 depicts an example system 100 to introduce channel reuse. The example system 100 includes multiple stations coupled to a PLC medium 130. Coupled to the PLC medium 130 are a first station 150 (“A”), a second station 152 (“B”), a third station 110 (“C”), and a fourth station 120 (“D”). The first station 150 and second station 152 may be part of a neighbor network 145 in some embodiments. The third station 110 and fourth station 120 may be part of a local network 105.

As shown in FIG. 1, a shared communication medium may host multiple communication networks. For example, multiple PLC networks may operate on a shared powerline (such as PLC medium 130). As part of determining whether to perform channel reuse with a neighbor communication network, a local communication network (e.g., the network stations in the local communication network) may determine whether reusing the channel will result in performance loss for some or all of the network stations in the local and/or neighbor communication networks. In this disclosure, a first transmission is said to not interfere with a second transmission if a recipient of the second transmission can properly receive the second transmission even during the first transmission. The interference caused by the first transmission may be zero, negligible, or below a threshold level associated with reception performance of the second transmission.

In channel reuse, a first and second stations may transmit at least partially simultaneously as long as a first transmission from the first station does not prevent reception of a second transmission from the second station, and vice versa. If the first transmission does not prevent reception of the second transmission, the first transmission is said to not interfere with the second transmissin. In one example of FIG. 1, the local network 105 and the neighbor network 145 may be capable of transmitting simultaneously on the same PLC medium 130 without interfering with each other and they may use the same PLC medium concurrently. This is referred to as neighbor network channel reuse. As an alternative to channel reuse, channel sharing is defined as a technique where the stations can only use the communication medium one-at-a-time so that transmissions do not overlap.

As an example of channel reuse, consider the example system 100. If the first station 150 is able to transmit data to the second station 152 during concurrent communications between the third station 110 and the fourth station 120, and without preventing reception of the concurrent communications, then the third station 110 may implement channel reuse whenever it detects a transmission from first station 150 to second station 152. Typically, a receiving station, such as fourth station 120 may determine a signal-to-interference-and-noise (SINR) value to quantify the signal quality compared to noise and interference. If the SINR is high enough, then the fourth station 120 may receive the transmission from the third station 110 even if the first station 150 is transmitting to the second station 152.

A channel reuse determination unit 128 may be used to determine whether channel reuse can be performed during received transmission. For example, the channel reuse determination unit 128 may determine a received signal strength, identifying information about a transmitting station in the neighbor network 145, identifying information about a receiving station in the neighbor network 145, a transmission data rate, transmission feedback (e.g., bit error rate, etc.), and other suitable performance measurements associated with the neighbor network 145. The identifying information of a transmitting station in the neighbor network and its network identity information can be extracted based, at least in part, on information in the received transmission. In one example, the identifying information of the transmitting station can be determined from a source terminal equipment identifier (STEI) field in a start of frame (SOF) delimiter of the received transmission.

Although the example described in FIG. 1 depicts neighbor network channel reuse, embodiments of the present disclosure are not so limited. For example, channel reuse may be performed between various pairs or groups of stations in a same local network. Channel reuse may also be performed between pairs or groups of stations in different networks. For example, using channel reuse it may be possible for the first station 150 to communicate with third station 110 concurrently with the second station 152 communicating with the fourth station 120.

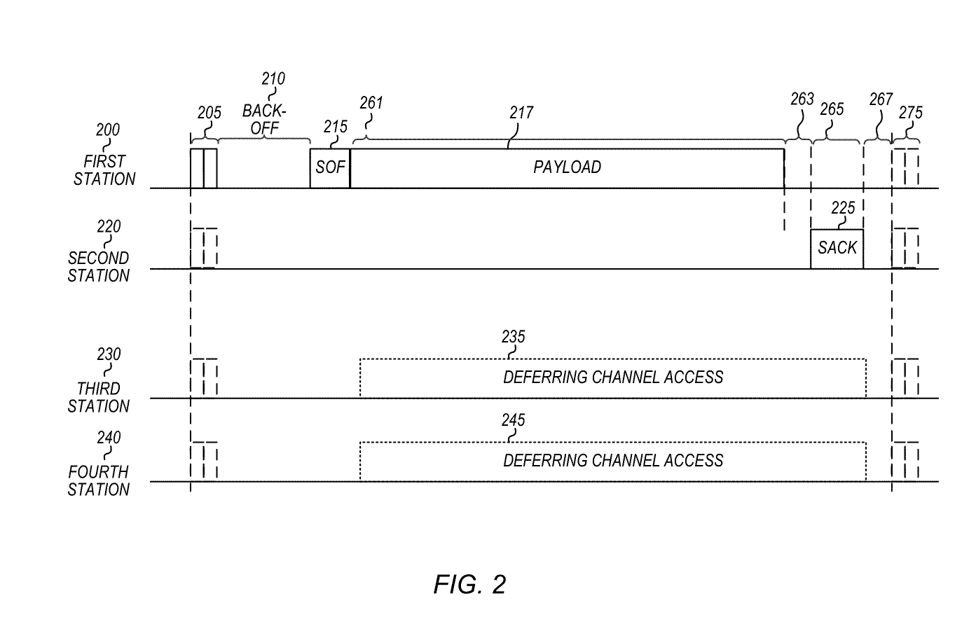

FIG. 2 illustrates behavior of stations in a typical PLC network. The PLC network may implement CSMA to limit interfering transmissions. The CSMA protocol has been adopted by the medium access control (MAC) protocols used in various multi-access communication systems (e.g., wireless/powerline LANs). In CSMA, a station may determine if the channel is being used by other stations in the network before the station transmits its data packet by sensing the communication medium. If the channel is currently occupied, the station defers its transmission until the channel becomes available. Otherwise, the station may access the channel with a certain probability which, in practice, is implemented by backing off the transmission for a short time period, where the back-off period length depends on the channel access probability.

Similar to the MAC protocol used in wireless local area networks (e.g., IEEE 802.11 WLANs), the MAC protocol commonly used in powerline communication (PLC) networks belongs to the CSMA family of protocols. When a first station 200 has a data packet to transmit and the channel is not occupied, first station 200 may send its priority symbols in the two priority resolution (PRS) slots 205. The priority symbols may indicate the transmission priority of the first station's pending data packet. For another station with lower transmission priority than first station 200, that other station may yield the channel to the station having higher priority (e.g., first station 200). After sending its priority symbols in the two PRS slots, if the first station 200 does not lose the channel contention due to priority, first station 200 may initiate random back-off procedure 210 by randomly selecting a number of contention slots from a specified range. If the channel is still free after the back-off procedure 210 ends, first station 200 may start to transmit its data packet 217. The data packet 217 may be encapsulated by a MAC layer header called the SOF delimiter 215, in which some control information (e.g., data packet transmission time 261) may be included in the reserved delimiter fields.

In the example in FIG. 2, the data packet 217 is directed to a second station 220. For example, the SOF delimiter 215 may include a destination address of the second station 220. If the second station 220 successfully receives the data packet 217, the second station 220 may acknowledge receipt with, for example, a selective acknowledgement (SACK) packet 225. The SACK packet 225 is transmitted following a response inter-frame space (RIFS) 263 time period that follows the end of the data packet 217. For illustration purposes, the time period associated with the SACK packet 225 may be referred to as an acknowledgement time period 265.

Meanwhile, based on the transmission time information in the SOF delimiter, a third station 230 and a fourth station 240 may start medium/channel access deferral time periods 235, 245, respectively, and resume contention for the channel after the current transmission completes. After the SACK packet 225, a contention interframe space (CIFS) 267 defines a delay before the next PRS slots 275. The stations may then transmit priority symbols in the next PRS slots 275 if they have data to transmit. Note that no concurrent transmissions occur in FIG. 2. As such, FIG. 2 depicts a PLC medium in which channel reuse is not being performed.

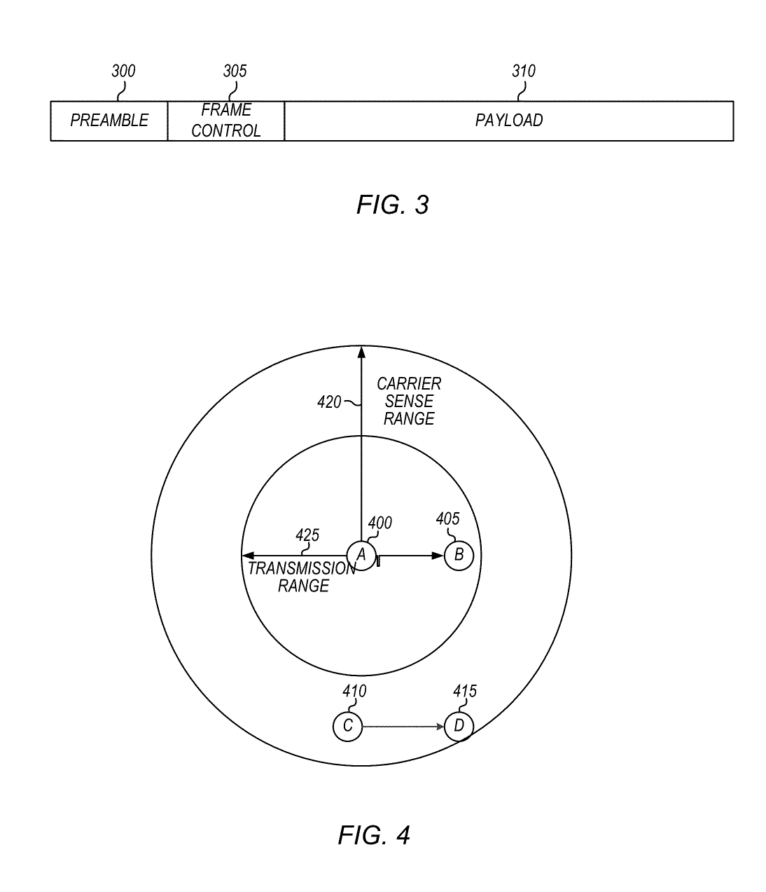

FIG. 3 illustrates an example media access control (MAC) protocol data unit (MPDU) format. In this disclosure, the term data packet or frame may refer to an MPDU. The example format of a MPDU may include a preamble 300, a frame control portion 305, and a payload 310. Preamble 300 and frame control 305 may be collectively referred to as the SOF delimiter. The preamble 300 could be a predetermined pattern that may be used by a receiver station to determine the start of the MPDU. The preamble 300 may also be used for carrier sensing. The frame control 305 portion of a MPDU may include control information, such as the source and destination address of the MPDU, the network identity to which the transmitter station of the MPDU belongs, information regarding the transmission time/length of the payload, and other channel access information. The payload 310 may include application data or management messages. For each data packet from the MAC layer, a physical (PHY) layer may organize the packet into bit stream data units known as PHY protocol data units (PPDU) for transmission over the transmission medium (e.g., powerline medium).

Signals transmitted over a transmission powerline medium may be contaminated by various noises or interference. For this reason, a delimiter may use robust modulation and encoding schemes to minimize the impact of potential noises and interference in, for example, the powerline medium. Therefore, robust carrier sensing and frame control functionality can be provided to powerline systems. Since the robustness may be at the cost of low transmission data rate, for payload transmissions, an adaptive rate may be used to balance transmission reliability and transmission data rate. Therefore, a preamble and frame control may use different modulation and coding schemes than those used for transmitting the payload. Different modulation and coding schemes of delimiters and payloads may result in different ranges in which delimiters and payloads will be successfully received by a station with a high probability.

FIG. 4 illustrates an example carrier sense range and an example transmission range in accordance with an embodiment of this disclosure. Two ranges, labeled as carrier sense range and transmission range, are shown for receiver station 400 in the illustrated embodiment. Delimiters transmitted within the carrier sensing range 420 may be decoded by the receiver station 400 with a high probability. However, since payloads may use a less robust modulation and coding scheme, payloads transmitted within transmission range 425 may be received by receiver station 400 with a high probability. Accordingly, payloads transmitted within the portion of carrier sense range 420 that does not overlap with transmission range 425 may not be received by receiver station 400 with high probability. Note that the transmission range may depend on the modulation and coding scheme used for payloads. In some situations, the transmission range 425 may be the same as the carrier sense range 420 if the payloads use the same modulation and coding scheme as delimiters. In other embodiments, if payloads use a more efficient modulation and coding scheme than delimiters, the transmission range 425 may be much smaller than the carrier sense range 420.

In some examples, if one station is in the carrier sense range of the other station, it does not necessarily mean that the two stations should always share the channel. FIG. 4 illustrates four stations 400, 405, 410, and 415. Stations 400 and 405 may form one network and stations 410 and 415 may form another network. Consider a scenario in which station 400 sends data to station 405 and station 410 sends data to station 415. Assuming all stations have the same carrier sense range and transmission range, FIG. 4 shows that stations 400 and 405 are in the carrier sense range of station 410. Likewise, stations 410 and 415 are in the carrier sense range of station 400. Although station 400 can receive delimiters from station 410, and station 415 from station 405, the signal strength attenuation from station 400 to station 415 may be large enough such that the SINR at station 400 is sufficiently high to receive payloads from station 405 with low bit error rates. Therefore, the channel may be reused for both networks. Similarly, as shown, the signal strength attenuation from station 410 to station 405 may be large enough such that the SINR at station 415 is sufficiently high to receive payloads from station 410 with low bit error rates.

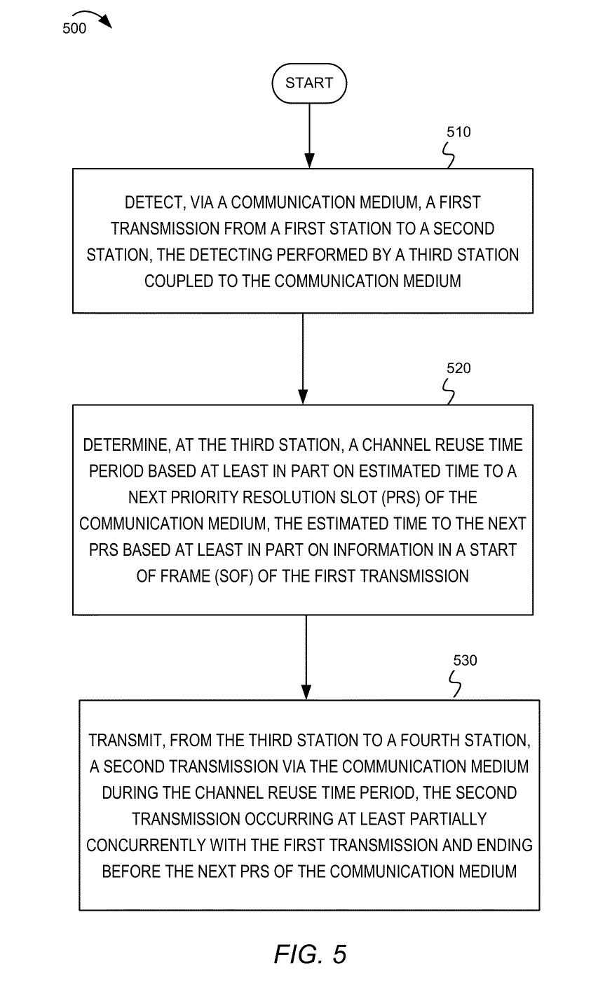

FIG. 5 depicts a flow diagram 500 with example operations for channel reuse in a powerline communication (PLC) network in accordance with an embodiment of this disclosure.

At block 510, the method includes detecting, via a communication medium, a first transmission from a first station to a second station, said detecting performed by a third station coupled to the communication medium.

At block 520, the method includes determining, at the third station, a channel reuse time period based at least in part on estimated time to a next priority resolution slot (PRS) of the communication medium, the estimated time to the next PRS based at least in part on information in a start of frame (SOF) delimiter of the first transmission.

In some embodiments, the channel reuse time period is determined such that the second transmission will end before a start of the acknowledgement time period associated with the first acknowledgement message to be transmitted from the second station to the first station responsive to the first transmission. In some embodiments, the channel reuse time period is based at least in part on an acknowledgement time period associated with a second acknowledgement message to be transmitted from the fourth station to the third station responsive to the second transmission. For example, the channel reuse time period may be determined such that the second acknowledgment message occurs concurrently with the first acknowledgement message.

At block 530, the method includes transmitting, from the third station to a fourth station, a second transmission via the communication medium during the channel reuse time period, the second transmission occurring at least partially concurrently with the first transmission and ending before the next PRS of the communication medium.

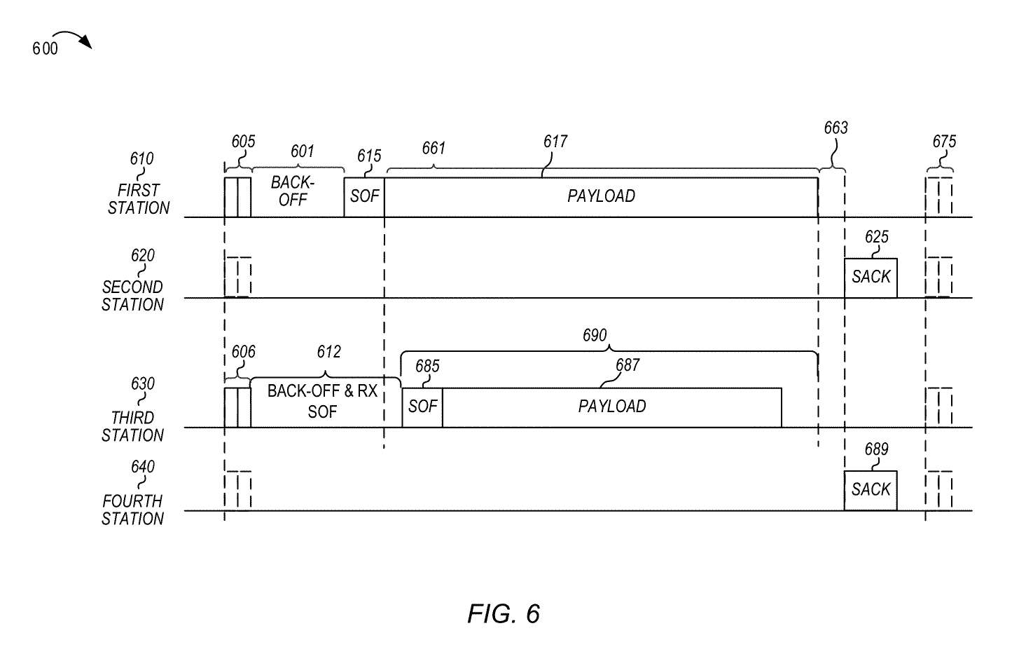

FIG. 6 is an example timing diagram 600 illustrating channel reuse with aligned acknowledgement messages in accordance with an embodiment of this disclosure. FIG. 6 depicts a first station 610, second station 620, third station 630, and fourth station 640. In FIG. 6, the first station 610 determines to transmit a data packet to the second station 620. The first station 610 can transmit one or more priority symbols in priority resolution (PRS) slots 605. The priority symbols indicate the transmission priority of the first station's pending data packet. In accordance with CSMA protocols, another network station with lower transmission priority will yield the channel to the network station with the higher transmission priority. After the two PRS slots 605, the first station 610 wins the channel contention due to transmission priority and the first station 610 initiates a random back-off procedure by deferring transmission for a randomly selected number of contention slots (depicted as back-off period 601). If the channel is still free/unoccupied after the back-off period 601 ends, the first station 610 can start to transmit its data packet. In some embodiments, the data packet may be encapsulated by a MAC layer header referred to as a start of packet (SOF) delimiter 615. In some embodiments, for each data packet from the MAC layer, the physical (PHY) layer can organize the packet into bit stream data units (e.g., PHY protocol data units (PPDU)) for transmission over the powerline medium. In one example, a PPDU can comprise a preamble, a packet control portion, and the payload. In this example, the preamble and packet control, together, maybe referred to as the “SOF delimiter.” The preamble may be a predetermined pattern that indicates the start of the PPDU. The packet control portion of the PPDU can include MAC and PHY related control information such as, the source and destination address of the PPDU, the network to which the transmitter station belongs, information required to demodulate the PPDU payload (e.g. modulation and coding information), the information regarding the transmission time/length 661 of the payload 617, and other channel access information. The payload can comprise application data, management messages, or NULL information (e.g., no payload). If the receiver station 620 successfully receives the packet, the receiver station 620 can transmit a first selective acknowledgement (SACK) packet 625. In FIG. 6, the first station 610 in the neighbor network transmits the SOF delimiter 615 and the payload 617. After the second station 620 successfully receives the payload 617, the second station 620 waits for the RIFS time period 663 and then transmits a the first SACK packet 625 to the first station 610. Following the first SACK 625 the next PRS slots 675 are opportunities for the stations to contend for the channel again.

In FIG. 6, because of the robust transmission of the delimiters (e.g., the SOF delimiter 615, the SACK packet 625, etc.) the third station 630 may detect the SOF delimiter 615 transmitted by the first station 610. The third station 630 may determine to reuse the channel concurrently with the data packet transmitted by the first station 610. As depicted in FIG. 6, the third station 630 also transmits priority symbols in the PRS slots 606 (e.g., at the same time as the first station 610). The third station 630 initiates a back-off time interval 612 (e.g., in accordance with CSMA channel contention procedures described above). During the back-off time interval 612, the third station 630 detects the SOF delimiter 615 transmitted by the first station 610. In some embodiments, the third station 630 may disregard the SOF delimiter 615. In other embodiments, the third station 630 may decode the SOF delimiter 615 to obtain information from the SOF delimiter. After the back-off time interval 612 elapses, the third station 630 can initiate its packet transmission by transmitting its SOF delimiter 685 and a payload 687, thus reusing the channel with the first station 610. The third station 630 may determine a channel reuse time period 690 during which the third station 630 will transmit the concurrent second transmission. As depicted in FIG. 6, the second data packet (also referred to as a second transmission) of the third station 630 overlaps at least partially with the first data packet (also referred to as the first transmission) of the first station 610.

In the example of FIG. 6, the channel reuse time period 690 was determined based at least in part on the duration of the payload 617 of the first transmission from first station 610. In one embodiment, the third station 630 may pad the second transmission so that the second transmission ends concurrently with the first transmission. In this way, the timing of the first SACK packet 625 may be aligned with a second SACK packet 689 transmitted from the fourth station 640 to the third station 630, responsive to the second transmission. In another embodiment, the third station 630 may determine a channel reuse time period based on the duration 661 of the payload 617 and/or the amount of data available for the third station 630 to transmit to the fourth station 640. The channel reuse time period should be such that the transmission from the third station 630 and the second SACK 689 (if present) will be completed before the next PRS slot 675.

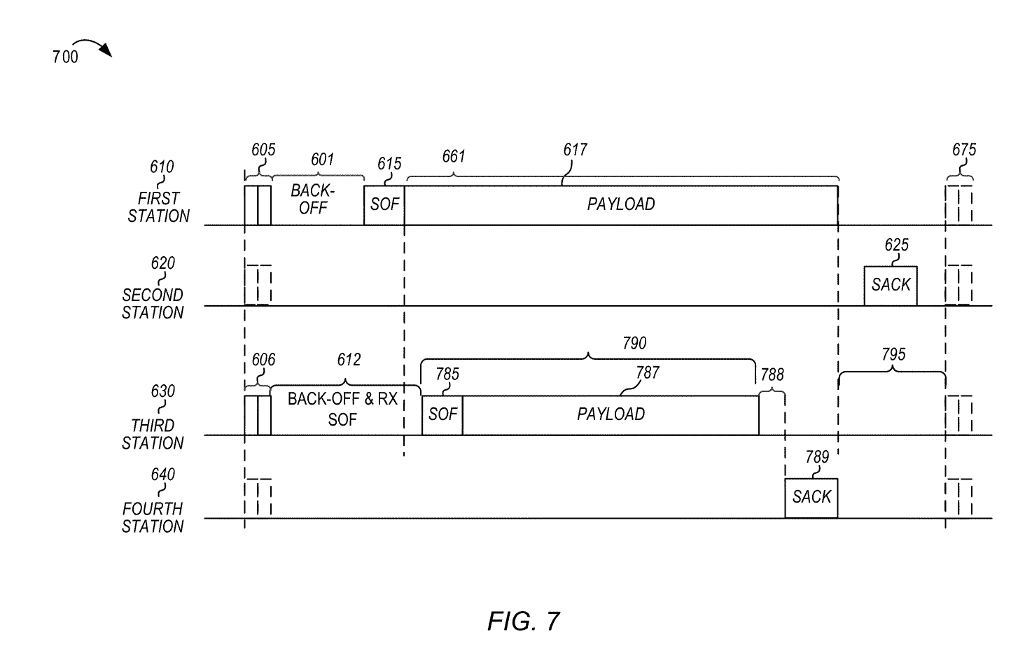

FIG. 7 is another example timing diagram 700 illustrating channel reuse without aligned acknowledgement messages in accordance with an embodiment of this disclosure. Similar to FIG. 6, the first station 610 determines to transmit a data packet to the second station 620. After transmitting one or more priority symbols in PRS slots 605, the first station 610 wins the channel contention due to transmission priority and initiates the random back-off procedure (depicted as back-off period 601) before transmitting a SOF delimiter 615 and payload 617. The SOF delimiter 615 may include control information such as, the source and destination address, the network to which the transmitter station belongs, information required to demodulate the PPDU payload (e.g. modulation and coding information), the information regarding the transmission time/length 661 of the payload 617, and other channel access information. If the receiver station 620 successfully receives the packet, the receiver station 620 can transmit a first selective acknowledgement (SACK) packet 625. Following the first SACK 625 the next PRS slots 675 are opportunities for the stations to contend for the channel again.

In FIG. 7, the third station 630 determines to reuse the channel concurrently with the data packet transmitted by the first station 610. As depicted in FIG. 6, the third station 630 also transmits priority symbols in the PRS slots 606 (e.g., at the same time as the first station 610). The third station 630 initiates a back-off time interval 612 (e.g., in accordance with CSMA channel contention procedures described above). During the back-off time interval 612, the third station 630 detects the SOF delimiter 615 transmitted by the first station 610.

The third station 630 may determine a channel reuse time period 790 during which the third station 630 will transmit the concurrent second transmission. In the example of FIG. 7, the channel reuse time period 790 was determined based at least in part on the duration of the payload 617 of the first transmission from first station 610. The third station 630 may determine the channel reuse time period 790 such that the second transmission (including SOF delimiter 785 and payload 787) from the third station 360 and the second SACK 789 (if present) will be completed before the end of the time period 661 associated with the first transmission (including payload 617). For example, the third station 630 may determine the time period 661 associated with the payload 617 of the first transmission by analyzing information in the SOF delimiter 615. The third station 630 may then subtract, from the time period 661, an acknowledgement time period associated with the second SACK 789, the RIFS 788, and any portion of the back-off time interval 612 that overlaps with the time period 661.

Following the SACK 789, the third station 630 and fourth station 640 may remain idle 795 until the next PRS slots 675.

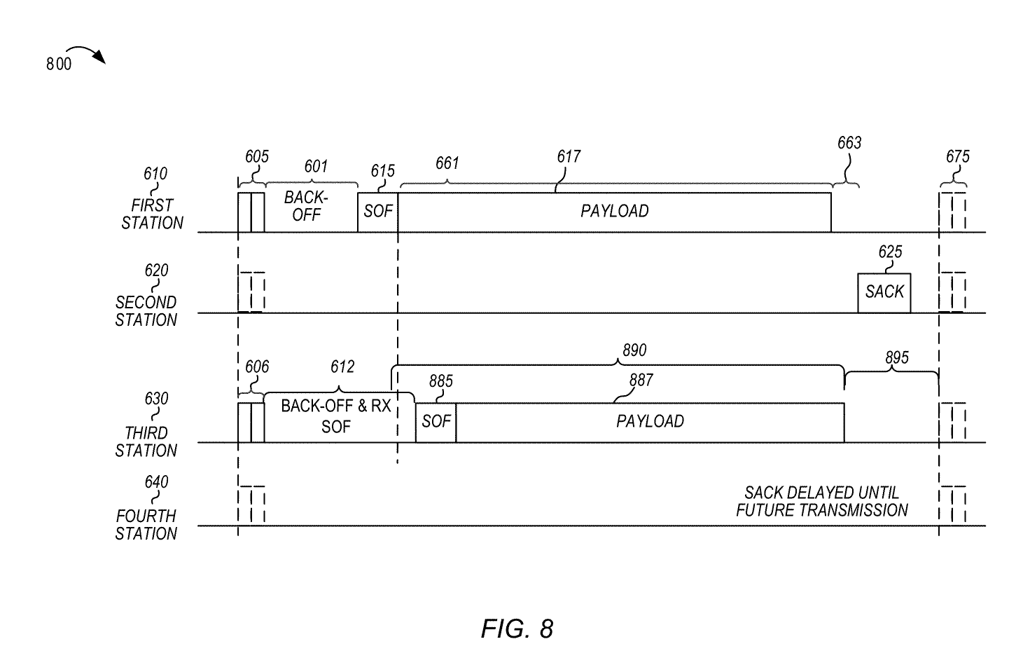

FIG. 8 is another example timing diagram 800 illustrating channel reuse in which a delayed acknowledgement message is used in accordance with an embodiment of this disclosure. Similar to FIGS. 6 and 7, the first station 610 determines to transmit a data packet to the second station 620. After transmitting one or more priority symbols in PRS slots 605, the first station 610 wins the channel contention due to transmission priority and initiates the random back-off procedure (depicted as back-off period 601) before transmitting a SOF delimiter 615 and payload 617. The SOF delimiter 615 may include control information such as, the source and destination address, the network to which the transmitter station belongs, information required to demodulate the PPDU payload (e.g. modulation and coding information), the information regarding the transmission time/length 661 of the payload 617, and other channel access information. If the receiver station 620 successfully receives the packet, the receiver station 620 can transmit a first selective acknowledgement (SACK) packet 625. Following the first SACK 625 the next PRS slots 675 are opportunities for the stations to contend for the channel again.

In FIG. 8, the third station 630 determines to reuse the channel concurrently with the data packet transmitted by the first station 610. As depicted in FIGS. 6 and 7, the third station 630 also transmits priority symbols in the PRS slots 606 (e.g., at the same time as the first station 610). The third station 630 initiates a back-off time interval 612 (e.g., in accordance with CSMA channel contention procedures described above). During the back-off time interval 612, the third station 630 detects the SOF delimiter 615 transmitted by the first station 610.

The third station 630 may determine a channel reuse time period 890 during which the third station 630 will transmit the concurrent second transmission. In the example of FIG. 8, the fourth station 640 will not send a second SACK prior to the next PRS slots 675. Therefore, the channel reuse time period 890 may utilize more of the time between the SOF delimiter 615 and the next PRS slots 675. The third station 630 may determine the channel reuse time period 890 such that the second transmission (including SOF delimiter 885 and payload 887) from the third station 360 will be completed prior to the next PRS slots 675. Following the channel reuse time period 890, the third station 630 and fourth station 640 may remain idle 895 until the next PRS slots 675.

It is noted that no second SACK is depicted in FIG. 8. The acknowledgement data responsive to the second transmission (SOF delimiter 885 and payload 887) will be included in a future transmission from the fourth station 640 to the third station 630. In some embodiments, the acknowledgement data may be combined with acknowledgement data for a further transmission from the third station 630 to the fourth station 640 following the next PRS 675 (or a subsequent PRS in which either the third station 630 or fourth station 840 win contention for the communication medium). The second SACK (not shown) may comprise a delayed acknowledgement, as described in draft HomePlug® AV2 specification, incorporated herein by reference.

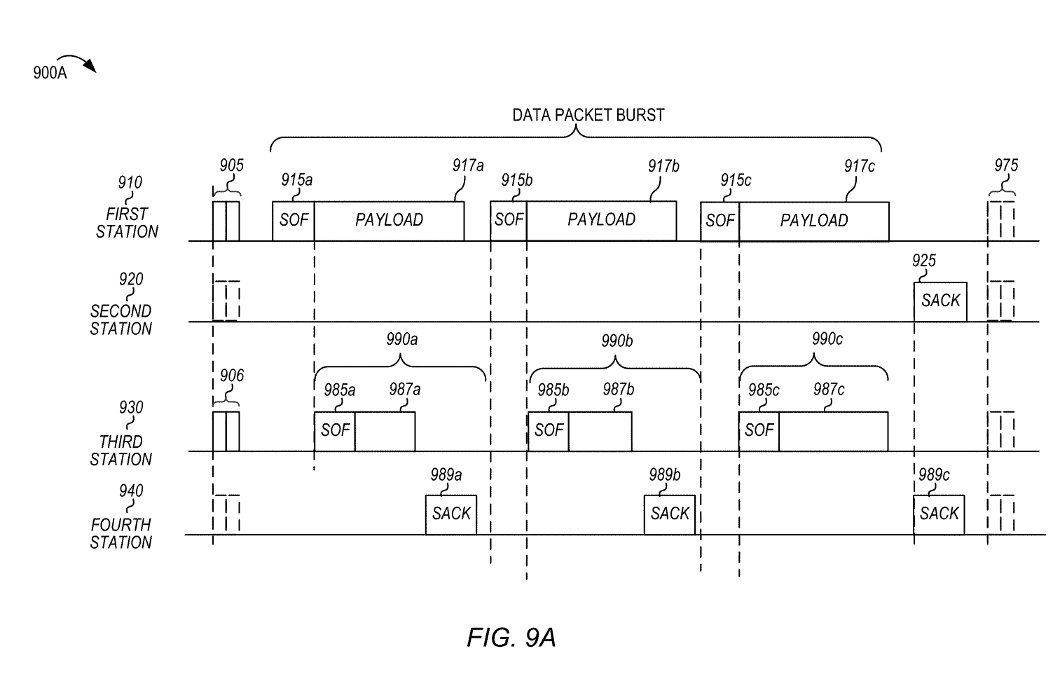

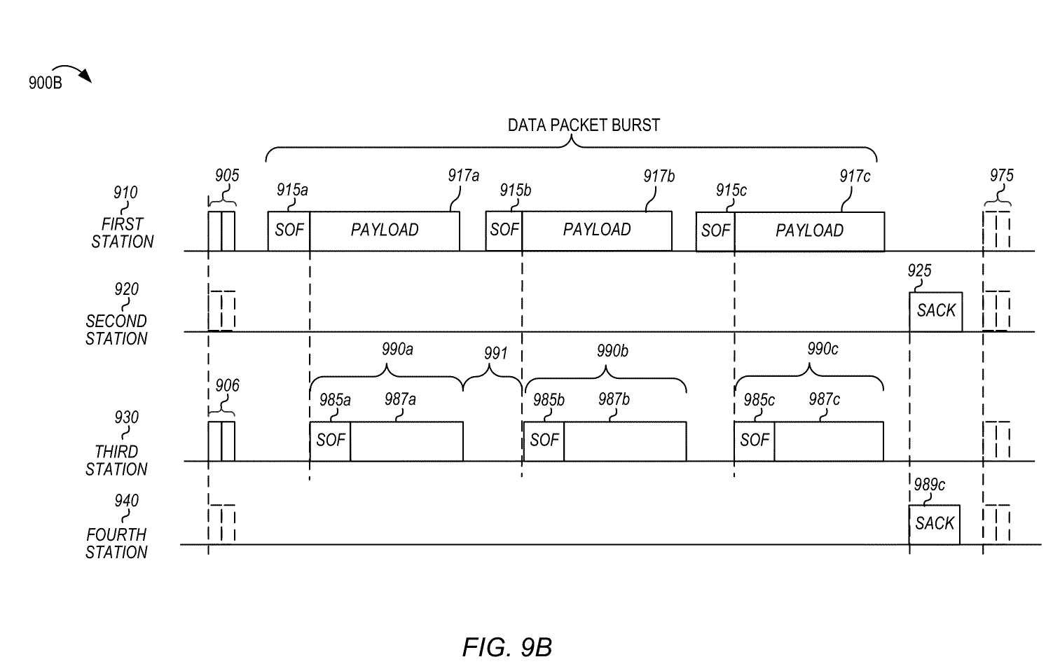

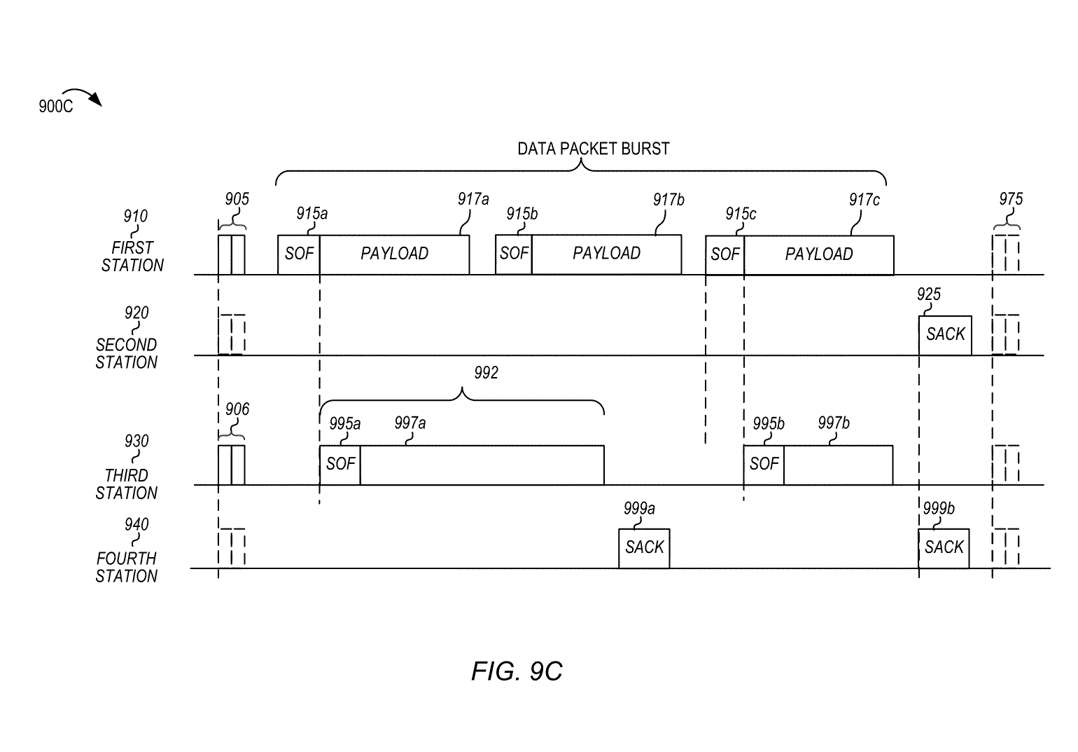

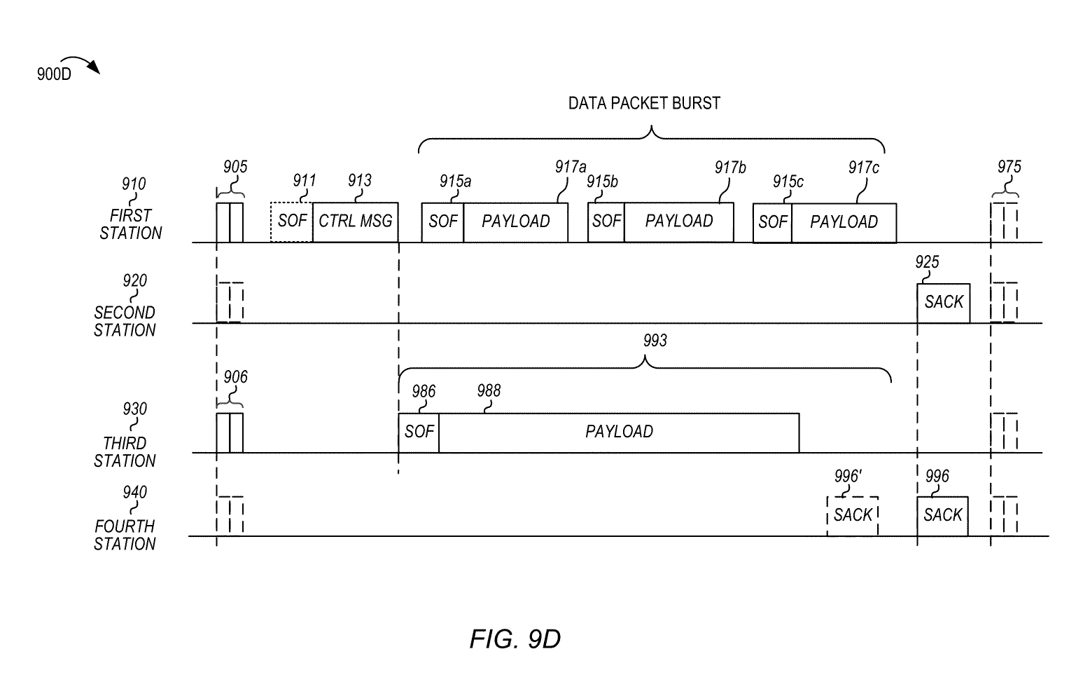

FIGS. 9A-9D are example timing diagrams illustrating channel reuse with a packet burst in accordance embodiments of this disclosure. A first station 910 vies for contention by transmitting one or more priority symbols in PRS slots 905. In FIGS. 9A-9B, the first station 910 will transmit a series of packets in a data packet burst (also referred to as an MPDU burst) before soliciting (or receiving) a SACK 925. The first packet (or MPDU) of the packet burst includes a first SOF delimiter 915a followed by payload 917a. The second packet of the packet burst includes a second SOF delimiter 915b followed by payload 917b. The third packet of the packet burst includes a third SOF delimiter 915c followed by payload 917c. The first station 910 may transmit multiple packets to the second station 920 and the second station 920 may transmit a SACK 925 after receiving a predetermined number of packets. For example, when communicating a packet burst of 10 packets, the receiving legacy device may transmit one acknowledgement message after receiving the 10 packets (instead of transmitting 10 acknowledgement messages for corresponding 10 packets).

In the packet burst, each SOF delimiter 915a, 915b, 915c may include an indicator for indicating whether it is the last packet in the packet burst. For example, SOF delimiter 915a may indicate that a further packet is included in the packet burst. Likewise, SOF delimiter 915b may also indicate that a further packet is included in the packet burst. The final packet may include an indicator in the SOF delimiter (such as SOF delimiter 915c) that indicates it is the final packet in the packet burst. In response to the final packet in the packet burst, the second station 920 may transmit SACK 925.

Following the SACK 925, the next PRS slots 975 provide opportunities for the stations to vie for contention again.

A third station 930 determines to reuse the channel with one or more concurrent transmissions from the third station 930 to the fourth station 940. The third station 930 may indicate priority symbols in the PRS slots 906 and then wait for a backoff period before sending a first transmission. The backoff period is such that the third station 930 is able to detect and analyze the first SOF delimiter 915a prior to determining a channel reuse time period.

In the example of FIG. 9A, the third station 930 determines a first channel reuse time period 990a based at least in part on information in the first SOF delimiter 915a. For example, the third station 930 may determine the first channel reuse time period 990a based on duration of the payload 917a that follows the first SOF delimiter 915a. During the first channel reuse time period 990a, the third station 930 transmits a first SOF delimiter 985a and first payload 987a to the fourth station 940. The fourth station 940 may respond with an SACK 989a responsive to the first SOF delimiter 985a and first payload 987a. The first channel reuse time period 990a may be limited so that the third station 930 and fourth station 940 complete transmissions before the second SOF delimiter 915b. In one embodiment, the third station 930 may observe the second SOF delimiter 915b to determine a second channel reuse time period 990b for a second packet (SOF delimiter 985b and payload 987b) to the fourth station 940. The fourth station 940 may respond with SACK 989b in response to the second packet. Next, the third station 930 may observe the third SOF delimiter 915c to determine a third channel reuse time period 990c for a third packet (SOF delimiter 985c and payload 987c). In one embodiment, the SACK 989c responsive to the third packet may occur before the SACK 925 or concurrently (as shown) with the SACK 925.

It is noted that in some embodiments, the third station 930 may utilize the first, second, and third channel reuse time periods 990a, 990b, 990c, for transmissions to different stations (not shown) rather than all directed to the same station.

In the example of FIG. 9B, the packets transmitted during the first, second, and third channel reuse time periods 990a, 990b, 990c may comprise a second packet burst that is aligned at least partially with a first packet burst (the SOF delimiter 915a, payload 917a, SOF delimiter 915b, payload 917b, SOF delimiter 915c and payload 917c). A burst interframe space (BIFS) 991 may be extended so that the time period between the first, second, and third channel reuse time periods 990a, 990b, 990c is long enough for the third station 930 to detect the SOF delimiters 915b, 915c of the first packet burst.

In the example in FIG. 9B, the second SACK 989c from the fourth station to the third station 930 is aligned in time with the first SACK 925 from the second station to the first station 910. In other examples, the second SACK 989c may not be aligned in time with the first SACK 925, but will end prior to the next PRS slots 975.

In the example of FIG. 9C, the third station 930 determines an extended channel reuse time period 992 based at least in part on information in the first SOF delimiter 915a. However, the third station 930 may estimate a length of two or more packets of the packet burst, thus setting an extended channel reuse time period 992 that is longer duration than a time period associated with just the payload 917a. For example, the third station 930 may observe previous transmissions between the first station 910 and second station and determine an average or minimum time duration associated with the previous transmissions. The average or minimum time duration associated with the previous transmissions may be used to determine the extended channel reuse time period 992.

The third station 930 may transmit a first SOF delimiter 995a and payload 997a during the extended channel reuse time period 992. The fourth station 940 may transmit a SACK 999a responsive to the first SOF delimiter 995a and payload 997a. After the extended channel reuse time period 992, the third station 930 may detect for the presence of the next packet from the first station 910 by detecting the third SOF delimiter 915c.

It is noted that the use of an extended channel reuse time period 992 may be used with the previously described per-packet channel reuse time periods, such as 990a, 990b, and 990c. Shown in FIG. 9C, the third station 930 has determined another channel reuse time period based on the third SOF delimiter 915c, and has transmitted a further SOF delimiter 995b and payload 997b. The SACK 999b may be received from the fourth station 940 responsive to the transmitted further packet (SOF delimiter 995b and payload 997b).

In the example of FIG. 9D, the third station 930 determines an extended channel reuse time period 993 based at least in part on information in a control message 913 from the first station 910. In FIG. 9D, the control message 913 may be sent by the first station 910 prior to the first station 910 transmitting the data packet burst. The control message may include a SOF delimiter 911. In one embodiment, the control message 913 comprises a Clear-to-Send (CTS) message transmitted by the first station 910 to reserve the communication medium for the first station 910 to transmit the data packet burst. In one embodiment, the first station 910 may determine a duration (such as a time period or quantity of data bytes) for the data packet burst and indicate the duration in the control message 913. The third station 930 may detect the control message 913 and determine the extended channel reuse time period 993 based on the duration indicated in the control message 913.

During the extended channel reuse time period 993, the third station 930 may transmit the SOF delimiter 986 and payload 988. A portion of the extended channel reuse time period 993 may also be used for a SACK 996′. Alternatively, a SACK 996 may be transmitted by the fourth station 940 aligned in time with the SACK 925 transmitted by the second station 920.

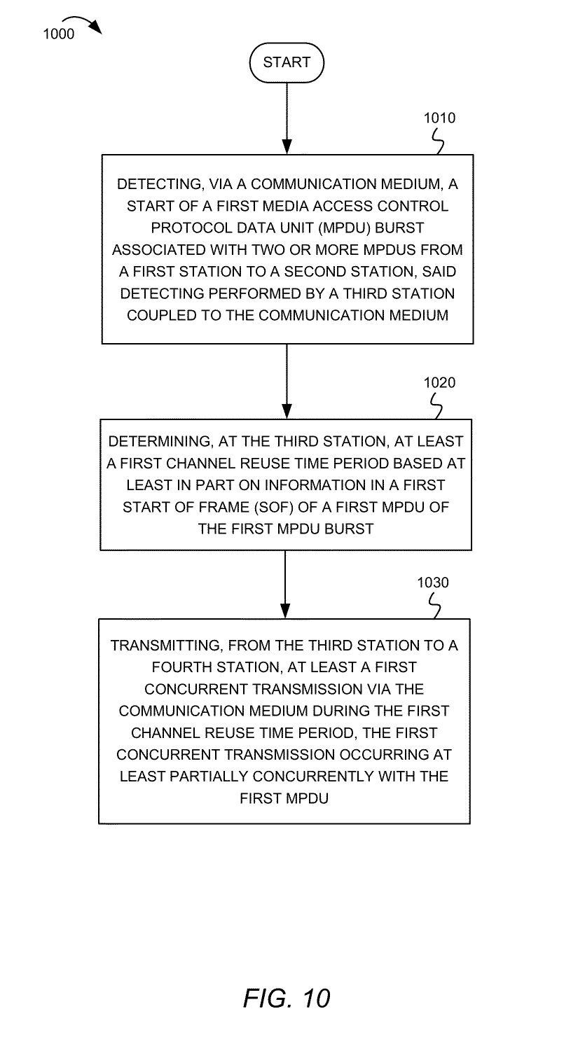

FIG. 10 depicts a flow diagram with example operations for channel reuse with a packet burst in accordance with an embodiment of this disclosure.

At block 1010, the method includes detecting, via a communication medium, a start of a first media access control protocol data unit (MPDU) burst associated with two or more MPDUs from a first station to a second station, said detecting performed by a third station coupled to the communication medium.

At block 1020, the method includes determining, at the third station, at least a first channel reuse time period based at least in part on information in a first start of SOF delimiter of a first MPDU of the first MPDU burst.

At block 1030, the method includes transmitting, from the third station to a fourth station, at least a first concurrent transmission via the communication medium during the first channel reuse time period, the first concurrent transmission occurring at least partially concurrently with the first MPDU.

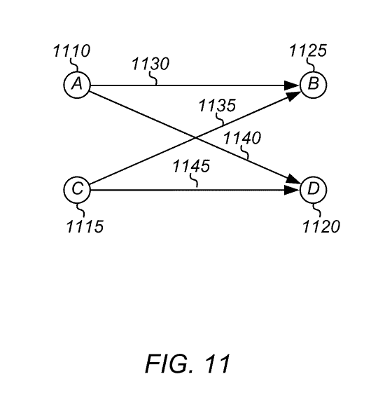

FIG. 11 is a conceptual diagram to illustrate determination of opportunistic channel reuse in accordance with an embodiment of this disclosure. When Station A 1110 is transmitting to Station B 1125, Station C 1115 can reuse the communication medium if the channel reuse does not cause significant interference (1135) to reception at Station B 1125, and if Station A's 1110 transmission will not cause significant interference (1140) for reception at Station D 1120. In one implementation, the decision making can be made based on the past signal and interference level measurements. For example, in one embodiment, Station A 1110 can provide information (e.g. transmission power, link budget, modulation and coding scheme used) in the SOF delimiter or CTS proceeding the SOF delimiter to enable stations C 1115 and D 1120 to determine how much interference station A 1110 can tolerate and how much interference station D 1120 will experience. Station D 1120 can provide information on whether it can tolerate interference from Station A 1110.

When station A 1110 is a legacy station and station C 1115 wants to reuse the channel with station A 1110, the following approaches can be used to limit the probability of station C 1115 causing strong interference 1135 at station B 1125. In one embodiment, a bit load estimator (BLE) threshold can be used by station C 1115 when it decodes the SOF delimiter from station A 1110. If the station A's transmission (1130) has a high BLE, then Station C 1115 can infer that Station B 1125 will likely tolerate interference 1135 from Station C 1115. Station C 1115 can use its BLE and attenuation from Station C 1115 to Station D 1120 to estimate the noise level at Station B 1125 and to estimate the impact of its interference 1135 at Station B 1125 more accurately. In one implementation, Station C 1115 can send one or more trial packets (1145) with or without transmit power control to Station D 1120 and verify if the transmission 1130 from Station A 1110 to Station B 1130 can tolerate the introduced interference 1135 by looking at the SACK (not shown) from Station B 1125.

This procedure can also be applied to the acknowledgment transmission (not shown) from Station B 1125 to Station A 1110 to determine whether the transmission from Station B 1125 to Station A 1110 can tolerate the inference from Stations C and D.

FIGS. 1-11 and the operations described herein are examples meant to aid in understanding various embodiments and should not limit the scope of the claims. Embodiments may perform additional operations, fewer operations, operations in parallel or in a different order, and some operations differently.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “unit” or “system.” Furthermore, aspects of the present disclosure may take the form of a computer program product embodied in one or more computer readable medium(s) having computer readable program code embodied thereon.

Any combination of one or more computer readable medium(s) may be utilized, with the sole exception being a transitory, propagating signal. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the present disclosure. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

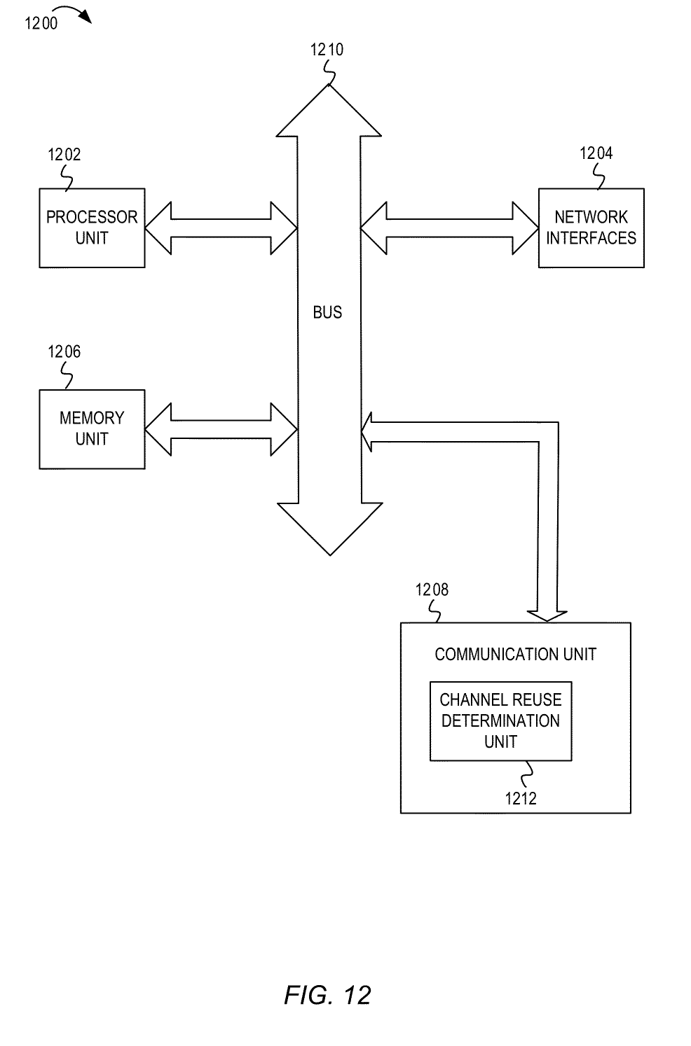

FIG. 12 is an example block diagram of one embodiment of an electronic device 1200 capable of implementing various embodiments of this disclosure. For example, the electronic device 1200 implement functionality described as any one of stations 110, 120, 230, 240630, 640, 930, 940. In some implementations, the electronic device 1200 may be an electronic device such as a laptop computer, a tablet computer, a mobile phone, a powerline communication device, a gaming console, or other electronic systems. In some implementations, the electronic device may comprise functionality to communicate across multiple communication networks (which form a hybrid communication network). The electronic device 1200 includes a processor unit 1202 (possibly including multiple processors, multiple cores, multiple nodes, and/or implementing multi-threading, etc.). The electronic device 1200 includes a memory unit 1206. The memory unit 1206 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 1200 also includes a bus 1201 (e.g., PCI, ISA, PCI-Express, HyperTransport®, InfiniBand®, NuBus, AHB, AXI, etc.). The electronic one or more network interfaces 1204 that may be a wireless network interface (e.g., a WLAN interface, a Bluetooth® interface, a WiMAX interface, a ZigBee® interface, a Wireless USB interface, etc.) or a wired network interface (e.g., a powerline communication interface, an Ethernet interface, etc.).

The electronic device 1200 may include a channel reuse determination unit 1212 configured to implement various embodiments described in the forgoing figures. For example, the channel reuse determination unit 1212 may determine the channel reuse time period based at least in part on at least one of the SOF delimiter of a received transmission, a control message, an estimated duration of a packet burst, or any of the various other examples described herein. The channel reuse determination unit 1212 may optionally be included as part of a communication unit 1208.

Any one of these functionalities may be partially (or entirely) implemented in hardware and/or on the processor unit 1202. For example, the functionality may be implemented with an application specific integrated circuit, in logic implemented in the processor unit 1202, in a co-processor on a peripheral device or card, etc. Further, realizations may include fewer or additional components not illustrated in FIG. 11 (e.g., video cards, audio cards, additional network interfaces, peripheral devices, etc.). The processor unit 1202, the memory unit 1206, network interfaces 1204 may be coupled to the bus 1201. Although illustrated as being coupled to the bus 1201, the memory unit 1206 may be directly coupled to the processor unit 1202.

While the embodiments are described with reference to various implementations and exploitations, these embodiments are illustrative and that the scope of the present disclosure is not limited to them. In general, techniques for selecting a transmission mode as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the present disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present disclosure.

What is claimed is:

1. A method for communicating in a network, the method comprising:
detecting, via a communication medium, a first transmission from a first station to a second station, said detecting performed by a third station coupled to the communication medium;
determining, at the third station, a channel reuse time period based at least in part on estimated time to a next priority resolution slot (PRS) of the communication medium, the estimated time to the next PRS based at least in part on information in a start of frame (SOF) delimiter of the first transmission; and
transmitting, from the third station to a fourth station, a second transmission via the communication medium during the channel reuse time period, the second transmission occurring at least partially concurrently with the first transmission and ending before the next PRS of the communication medium.

2. The method of claim 1, wherein the channel reuse time period is based at least in part on a time period associated with an acknowledgement message to be transmitted from the fourth station to the third station.

3. The method of claim 2, further comprising:
receiving, at the third station, the acknowledgement message from the fourth station.

4. The method of claim 3, wherein receiving the acknowledgement message from the fourth station comprises receiving the acknowledgement message prior to the end of the first transmission from the first station to the second station.

5. The method of claim 3, wherein receiving the acknowledgement message from the fourth station comprises receiving the acknowledgement message at a same time as a different acknowledgement message from the second station to the first station.

6. The method of claim 3, wherein receiving the acknowledgement message from the fourth station comprises receiving the acknowledgement message in a subsequent transmission from the fourth station to the third station after the next PRS.

7. The method of claim 6, wherein the subsequent transmission comprises a delayed acknowledgement message.

8. The method of claim 1, further comprising:
determining a time period associated with a first acknowledgement message to the first transmission and during which the first acknowledgement message will be transmitted by the second station to the first station, wherein the channel reuse time period is based at least in part on the time period associated with the first acknowledgement message.

9. The method of claim 8, wherein the channel reuse time period is determined such that the second transmission will end before a start of the time period associated with the first acknowledgement message.

10. The method of claim 8, wherein the channel reuse time period is determined such that a second acknowledgment message to be transmitted by the fourth station to the third station occurs concurrently with the first acknowledgement message.

11. The method of claim 8, wherein the channel reuse time period is determined such that the second transmission will end before a start of the time period associated with the first acknowledgement message.

12. The method of claim 1, further comprising, prior to determining the channel reuse time period,
detecting previous transmissions between the first station and the second station, wherein the channel reuse time period is based at least in part on durations associated with the previous transmissions.

13. A communication station, comprising:
a network interface configured to couple the communication station to a communication medium and configured to detect, via the communication medium, a first transmission from a first station to a second station; and
a channel reuse determination unit configured to:
determine a channel reuse time period based at least in part on estimated time to a next priority resolution slot (PRS) of the communication medium, the estimated time to the next PRS based at least in part on information in a start of frame (SOF) delimiter of the first transmission; and
cause the network interface to transmit a second transmission to another station via the communication medium during the channel reuse time period, the second transmission occurring at least partially concurrently with the first transmission and ending before the next PRS of the communication medium.

14. The communication station of claim 13, further comprising:
the channel reuse determination unit configured to determine a time period associated with a first acknowledgement message to the first transmission and during which the first acknowledgement message will be transmitted by the second station to the first station, wherein the channel reuse time period is based at least in part on the time period associated with the first acknowledgement message.

15. The communication station of claim 14, further comprising:
the channel reuse determination unit configured to determine the channel reuse time period such that a second acknowledgment message to be transmitted by a fourth station to a third station occurs concurrently with the first acknowledgement message.

16. A method for communicating in a network, the method comprising:
detecting, via a communication medium, a start of a first media access control protocol data unit (MPDU) burst associated with two or more MPDUs from a first station to a second station, said detecting performed by a third station coupled to the communication medium;
determining, at the third station, at least a first channel reuse time period based at least in part on information in a first start of frame (SOF) delimiter of a first MPDU of the first MPDU burst; and
transmitting, from the third station to a fourth station, at least a first concurrent transmission via the communication medium during the first channel reuse time period, the first concurrent transmission occurring at least partially concurrently with the first MPDU.

17. The method of claim 16, wherein transmitting at least the first concurrent transmission comprises:
transmitting the first concurrent transmission at least partially concurrently with a first MPDU of the first MPDU burst; and
transmitting a second concurrent transmission at least partially concurrently with a second MPDU of the first MPDU burst.

18. The method of claim 17,
wherein the first concurrent transmission and the second concurrent transmission comprise a second MPDU burst from the third station to the fourth station, the second MPDU burst associated with two or more MPDUs that are aligned at least partially in time with the two or more MPDUs of the first MPDU burst from the first station to the second station, and
wherein determining at least the first channel reuse time period comprises determining the first channel reuse time period based at least in part on information in the first start of frame (SOF) delimiter of the first MPDU of the first MPDU burst, and determining a second channel reuse time period based at least in part on information in a second SOF delimiter of the second MPDU of the first MPDU burst.

19. The method of claim 16,
wherein determining at least the first channel reuse time period comprises:
estimating a duration of the first MPDU burst, based in part on at least one of a previous MPDU burst from the first station to the second station, a control message indicating the duration of the first MPDU burst, or a clear-to-send (CTS) transmission from the first station; and
determining the first channel reuse time period based at least in part on estimated time to a next priority resolution slot (PRS) of the communication medium, the estimated time to the next PRS based at least in part on the duration of the first MPDU burst.

20. The method of claim 19, further comprising:
receiving a control message prior to the first MPDU of the first MPDU burst, the control message indicating the duration of the first MPDU burst, and
wherein determining at least the first channel reuse time period comprises determining the first channel reuse time period based at least in part on the control message.
